(19) United States
(12) Patent Application Publication
(10) Pub. No.: US 2006/0135346 A1
(43) Pub. Date: Jun. 22, 2006

(54) Method of regenerating catalyst

(76) Inventors: Hiroya Nakamura, Mie (JP); Kazuharu Tazawa, Mie (JP); Isao Teshigahara, Mie (JP)

Correspondence Address: WENDEROTH, LIND & PONACK, L.L.P., 2033 K STREET N. W., SUITE 800, WASHINGTON, DC, 20006-1021, US

(21) Appl. No.: 10/532,982

(22) PCT Filed: Aug. 20, 2004
(86) PCT No.: PCT/JP04/11968

§ 371 Date: Jun. 3, 2005

(30) Foreign Application Priority Data
Aug. 22, 2003 (JP) 2003-298879

(51) Int. Cl. B01J 20/34

(52) U.S. Cl. 502/20

(57) ABSTRACT

An object is to efficiently separate catalyst grains from substantially inert grains and, optionally, separate a plurality of catalyst grains from one another, to thereby efficiently perform catalyst regeneration. After taking a catalyst-containing component containing a solid catalyst component deteriorated in a reaction, out of a fixed-bed reactor, the solid catalyst component is regenerated. If a plurality of components having different shapes from one another are contained as the solid catalyst components, after taking-out step, catalyst component separation step for separating such solid catalyst components from one another is performed and, then, the solid catalyst components are regenerated. Further, if an inert component is contained as the catalyst-containing component, after the taking-out step, an inert component separation step for separating the inert component is performed and then the solid catalyst component is regenerated.

### TECHNICAL FIELD

The present invention relates to a method for regenerating a solid catalyst to be used in a fixed-bed reactor.

### BACKGROUND ART

A fixed-bed catalyst reactor industrially employed has a merit in that, since a flow of reaction gas can ordinarily be approximated to a forced-out flow, the reaction yield is high and intermediate products of sequential reactions can be taken out in high yield. On the other hand, since thermal transmission capacity of the fixed-bed is low and removal or replenishment of reaction heat is not sufficiently performed, temperature in a catalyst layer becomes uneven and, in a case of an intensive exothermic reaction such as an oxidation reaction, a temperature peak is generated in the layer and it becomes difficult to control the temperature and, then, there is a risk of allowing the reaction to proceed in an out-of-control manner.

Further, in order to obtain a targeted product at high yield, it is necessary to allow diameters of solid catalyst grains to be as small as possible and diffusion resistance in grains to be low; however if the diameters of the solid catalyst grains are allowed to be unduly small, a pressure loss becomes large, thereby increases the risk of such out-of-control reaction and, also, if the targeted product is an intermediate product, a progression of sequential reactions goes forward, which is unfavorable.

In order to prevent the reaction from proceeding in an out-of-control manner and to reduce the pressure loss due to generation of temperature peaks as described above, various methods have been proposed. As an example of a catalytic reaction for producing acrolein, methacrolein or the like by performing a catalytic vapor-phase oxidation on propylene, isobutylene, t-butanol or the like by using air or a gas containing molecular oxygen, there is a report in which, by allowing a formed catalyst to have a ring shape instead of a columnar shape, the pressure loss can be suppressed and, further, a heat removal effect can be enhanced (see Patent Documents 1 and 2).

However, only contriving a shape of the catalyst is not sufficient for substantially reducing the pressure loss and preventing a partial temperature peak. Therefore, it has been also proposed to fill a filling auxiliary which is inert to the reaction, mixed with the catalyst. As an example of a catalytic reaction in which acrolein and acrylic acid are produced by vapor-phase oxidation of propylene, it has been proposed in Patent Document 3 that, in order to suppress heat generation in the vicinity of an inlet, an inert material is mixed such that the catalyst filling ratio is stepwise increased from the inlet to an outlet until it reaches 100%. Further, as an example of a steam reforming reaction of a hydrocarbon-type fuel, mixing a catalyst and a filling auxiliary is described in Patent Document 4 in which use of a Raschig ring made of stainless steel is mentioned in an embodiment. Still further, besides these proposals, in order to solve problems in the aforementioned fixed-bed reactor, mixtures of various types of inert materials in various types of shapes have been proposed and industrially used widely.

On the other hand, in regard to the solid catalyst to be used in the fixed-bed reactor, various proposals for methods for regenerating the catalyst used at a plant operation have been made.

It is well known that a molybdenum-bismuth-iron type compound oxide catalyst is useful in a selective oxidation reaction, for example, from propylene to acrolein and from isobutylene or t-butanol to methacrolein and performance deterioration of this catalyst is caused mainly by loss of molybdenum through sublimation thereof.

As a method for regenerating such a deteriorated catalyst, a method in which the deteriorated catalyst is subjected to heat treatment in an atmosphere of air or a gas containing oxygen to allow it to be in contact with air under heating condition, to thereby allow molybdenum to be diffused in a catalyst grain on a surface thereof and recover a catalytic performance is disclosed in Patent Documents 5 and 6.

Further, a molybdenum-vanadium type compound oxide catalyst is useful in vapor-phase catalytic oxidation reaction to which an unsaturated aldehyde such as acrolein or methacrolein is subjected to produce a corresponding unsaturated carboxylic acid such as acrylic acid or methacrylic acid and, it is considered that performance deterioration of this catalyst is caused not only by an activation decrease caused by accumulation of a carbon-containing compound on a surface of the catalyst but also by loss of molybdenum through sublimation thereof.

As a method for regenerating such deteriorated catalyst, a regeneration method in which the deteriorated catalyst is heat treated in the temperature range of from 260° C. to 450° C. in a mixed gas containing at least 3% by volume of molecular oxygen and at least 0.1% by volume of steam with the catalyst filled in a reactor, to thereby remove accumulated carbon-containing compound which is a cause of the activation decrease is disclosed in Patent Documents 7 and 8.

However, although both of the aforementioned methods are effective in temporarily recovering the catalytic performance by allowing a distribution gas to be distributed in a specified temperature atmosphere with the deteriorated catalyst filled in the reactor, regeneration effect thereof is not sufficient because the sublimed component of molybdenum lost in a long reaction can not be replenished and also, it is practically difficult to continue an operation with the catalyst filled in the reactor due to a decrease in strength of the solid catalyst over time or an increase in pressure loss in a catalyst layer caused by pulverization of a surface portion of the catalyst by a reaction gas.

Against these methods, a method in which the deteriorated catalyst is taken out of the reactor and then regenerated is considered. As a method for regenerating a molybdenum-bismuth-iron type multi-component oxide catalyst, a method in which, in order to replenish molybdenum which has been scattered off by being deteriorated, substantially inert molybdenum oxide or unused catalyst powder is mixed or, after being crushed, mixed to the catalyst and then the resultant catalyst is subjected to heat treatment is disclosed in Patent Documents 9 and 10.

Further, as a method for regenerating the catalyst which, in fresh form, contains, as basic constituents, elements Mo, W, V and Cu in oxide form, a method is disclosed in Patent Document 11 in which regeneration is performed by an action of an oxidizing agent or method and by a solubilizing action of an aqueous ammonia solution to which acetic acid and/or an ammonium salt thereof has been added, followed with subsequent drying and calcination, and metals are replenished such that amounts of the metals are made up to respective original values.

Besides, a method in which two different catalyst components are individually filled in one reactor in a separate manner and an inert material is interposed between the two types of catalyst components and then, a plurality of reactions are continuously performed in the one reactor is disclosed in Patent Document 12.

Patent Document 1: JP-B No. 62-36739

Patent Document 2: JP-B No. 62-36740

Patent Document 3: JP-B No. 53-30688

Patent Document 4: JP-A No. 4-119901

Patent Document 5: JP-B No. 5-29502

Patent Document 6: JP-B No. 5-70503

Patent Document 7: Japanese Patent No. 2702864

Patent Document 8: Japanese Patent No. 2610090

Patent Document 9: JP-A No. 7-165663

Patent Document 10: JP-A No. 9-12489

Patent Document 11: JP-A No. 6-233938

Patent Document 12: JP-A No. 11-130722

### DISCLOSURE OF THE INVENTION

Problems that the Invention Intends to Solve

However, in the aforementioned Patent Documents 9 to 11, there is no specific description about a method for efficiently separating the grains which are substantially inert to the reaction from the catalyst grains. When separation of the grains which are substantially inert to the reaction is insufficient, an amount of the catalyst to be subjected to a regeneration treatment is increased and, accordingly, treatment efficiency is decreased. Further, when a recovery ratio of the catalyst grains at the time of separation is decreased, it becomes necessary to replenish new catalyst grains, which is not efficient.

Further, in the aforementioned Patent Document 12, when the catalyst is taken out of the reactor for the purpose of regenerating the catalyst, since it is not favorable from the standpoint of efficiency to take out different types of catalyst components from each other in a separate manner, it is likely to take them out all at a time. It is, then, necessary to isolate each of the catalyst components and the inert material from the thus-taken out catalysts.

Thus, an object of the present invention is to efficiently separate catalyst grains from substantially inert grains and, optionally, separate a plurality of catalyst grains from one another, to thereby efficiently perform catalyst regeneration.

Means for Solving the Problems

According to the present invention, the aforementioned problems have been solved by using a method for regenerating a catalyst, comprising the steps of taking a catalyst-containing component comprising the solid catalyst component deteriorated in a reaction, out of a fixed-bed reactor, and regenerating a solid catalyst component.

Further, the catalyst-containing component comprises a component substantially inert to the aforementioned reaction and the taking-out process is followed by an inert component separation step for separating the component substantially inert to the aforementioned reaction.

Still further, the aforementioned solid catalyst component comprises a plurality of components having different shapes from one another and, the aforementioned taking-out step is followed by catalyst component separation step for separating such solid catalyst components from one another.

In the aforementioned inert component separation process or the catalyst component separation process, a grain body having a minor axis different from that of the aforementioned solid catalyst component is used as the component substantially inert to the aforementioned reaction and sieving operation is performed by using a screen having rectangular openings of length a×length b which satisfies the following conditions (1) to (3):

(1) a<b;

(2) a is larger than a minor axis of a grain having a small minor axis and smaller than a minor axis of a grain having a large minor axis; and

(3) b is larger than a major axis of a grain having a small minor axis.

Further, as the aforementioned inert component separation step or the catalyst component separation step, a step for performing separation by utilizing a difference in ease of rolling caused by a difference in sphericity between the solid catalyst component and the component substantially inert to the reaction or a difference in ease of rolling caused by a difference in sphericity among a plurality of solid catalyst components having different shapes from one another may be adopted.

Still further, as the inert component separation step or the catalyst component separation step, a step for performing separation by utilizing a difference in ease of crushing caused by a difference in falling strength between the solid catalyst component and the component substantially inert to the reaction or a difference in ease of crushing caused by a difference in falling strength among a plurality of solid catalyst components having different shapes from one another may be adopted.

### ADVANTAGES OF THE INVENTION

According to the present invention, as a method for regenerating a solid catalyst deteriorated by being used in a fixed-bed reactor, a catalyst-containing component is taken out of a fixed-bed reactor, one or plural types of solid catalyst components and a component substantially inert to a predetermined reaction contained in the catalyst-containing component are separated from one another by a predetermined method and, then, the resultant individual components are regenerated, to thereby obtain a catalyst which has a substantially same performance as a new catalyst, and which is capable of being filled again in the reactor and used.

### BEST MODE FOR CARRYING OUT THE INVENTION

Hereinafter, the present invention will be described in detail.

A method for regenerating a catalyst according to the present invention is a method for regenerating a solid catalyst component, after passing through a step of taking a catalyst containing-component comprising a solid catalyst component deteriorated in a reaction, out of a fixed-bed reactor.

The aforementioned catalyst-containing component means a component containing a solid catalyst component which exerts a catalytic action and, optionally, besides the solid catalyst component, may contain a component substantially inert to the reaction (hereinafter, referred to also as “inert grain body”) and the like.

The aforementioned solid catalyst component means a component which exerts a catalytic action in the reaction. This solid catalyst component may comprise a component having a single catalytic action and, if a plurality of such reactions are performed in one fixed-bed reactor, may comprise a plurality of components having different catalytic actions from one another.

Further, the aforementioned inert grain body means a material which substantially does not exert activity in the aforementioned reaction, constitutes a solid catalyst component and does not include an inert component for carrying a catalyst main body.

The aforementioned reaction is not particularly limited, but a reaction process in which propylene, isobutylene or tert-butanol is subjected to a catalytic vapor-phase oxidation reaction to produce a corresponding unsaturated aldehyde and another reaction process in which an unsaturated aldehyde such as acrolein or methacrolein is subjected to the catalytic vapor-phase oxidation reaction to produce a corresponding unsaturated carboxylic acid can be cited.

Further, as the catalyst main body which constitutes the solid catalyst component to be used in the reaction process for producing the unsaturated aldehyde, a compound oxide catalyst comprising, as main components, molybdenum, bismuth and iron may be used. Still further, as the catalyst main body which constitutes the solid catalyst component to be used in the reaction process for producing the unsaturated carboxylic acid, a compound oxide catalyst comprising, as main components, molybdenum and vanadium may be used.

As the inert component for carrying the catalyst main body of the solid catalyst component, silica, alumina, zeolite and the like may be used. Further, as the inert grain body, silica, alumina, zeolite and the like may be used.

Next, a process for separating the inert grain body from the catalyst-containing component deteriorated in the reaction (hereinafter referred to as “inert component separation step”) and, if a plurality of solid catalyst components are contained, a step for separating the solid catalyst components (hereinafter referred to as “catalyst component separation step”) from one another, and a method for regenerating a catalyst main body in the thus-separated solid catalyst component will be described.

As for the grain body comprising each of the solid catalyst components, there are many of which compression strength as a grain has decreased in the reaction of long hour or the shape at the time of initial filling is not maintained due to pulverization of a surface of the grain body by the reaction gas. Therefore, in order to obtain a sufficient regeneration effect, it is necessary, after passing through an appropriate crushing step, to execute re-forming again. At this time, it is necessary to separate solid catalyst components from one another.

Thus, it is preferable to perform the catalyst component separation step after the taking-out step. Further, in order to perform the catalyst component separation step, the plurality of solid catalyst components may have different shapes from one another to facilitate physical separation.

Further, in regenerating the catalyst-containing component deteriorated in the reaction, it is possible to perform such regeneration without separating the inert grain body, but, since the amount of a material to be handled at the time of regeneration becomes large compared with that in a case of separating the inert grain, which is not efficient. Moreover, as for the grain body comprising the solid catalyst components contained in the catalyst-containing component, there are many of which compression strength as a grain has decreased in the reaction of long hour or the shape thereof at the time of initial filling is not maintained due to pulverization of the surface of the grain body by the reaction gas. Therefore, in order to obtain a sufficient regeneration effect, it is necessary, after passing through an appropriate crushing step, to execute forming again. At this time, it is necessary to separate the solid catalyst components from one another. Unless the inert grain body is separated, a crushing-forming operation can not be performed.

Thus, it is preferable to perform the inert component separation step after the aforementioned taking-out step. Further, in order to perform the aforementioned inert component separation step, the inert grain body may have different shapes from one another to facilitate physical separation from the solid catalyst component.

As for the aforementioned inert component separation step or the catalyst component separation step, the following separation methods may be used. These methods can be performed individually or in combinations. The selection thereof may be made depending on the shape of each solid catalyst component or the inert grain body in the catalyst-containing component and the physical property thereof such as the falling strength.

(Separation Method 1) Sieving Method

Firstly, a sieving method will be described below. The term “sieve” as used herein is a generic term denoting a tool, a device or an apparatus provided with a net which is a raw material or a factor having given openings and, a unit operation for separating an article which passes through the net from another article which does not pass through the net is called as “sieving”. An apparatus to be used in performing the sieving is not particularly limited so long as the apparatus has a function of sieving.

The screen to be ordinarily used in the sieving operation is generally a type having square openings and, the article which passes through the screen and another article which does not pass through the screen can be separated from each other by the size of a minimal diameter of a projection-circumscribing circle of a grain, the minimal diameter of the projection-circumscribing circles of a solid catalyst component and an inert grain body to be separated are in many case approximately equal to each other in order to maintain uniformity at the time of filling and, thus it is difficult to perform such separation with a screen having square openings. In such occasion, by using a grain body having a different minor axis from that of co-existing other solid catalyst components as the inert grain body or the solid catalyst component and using a screen having a mesh of a rectangular opening of length a×length b which satisfies all of the following conditions (1) to (3), the solid catalyst component and the inert grain body, or the solid catalyst components can efficiently be separated from each other:

(1) a<b;

(2) a is larger than the minor axis of a grain having a small minor axis and smaller than the minor axis of a grain having a large minor axis; and

(3) b is larger than the major axis of a grain having a small minor axis.

The major axis of grain refers to b, among three axes b₁, l and t defined when one grain is at a standstill in a most stable position, while the minor axis of grain means a smaller one between l and t.

b₁: a minimal distance between two parallel lines tangent to a contour on a plane of a grain;

l: a maximal distance between the two parallel lines in the direction perpendicular to b₁; and

t: a maximal distance between parallel planes parallel to a horizontal plane and tangent to a grain surface.

By using the aforementioned inert grain body or the solid catalyst component and by using a screen satisfying the aforementioned conditions, the solid catalyst component and the inert grain body, or the solid catalyst components can efficiently be separated from each other in an easy manner.

(Separation Method 2) Shape Separation Method

Next, a shape separation method will be described below. The shape separation ordinarily refers to a method for separating a non-spherical grain from a spherical grain and, in a further generalized sense, refers to a method for separating grains having different sphericity from each other. The sphericity refers herein to a value represented by the following formula:

Sphericity=surface area of true sphere having the same volume as that of grain/surface area of grain.

Namely, it is a method for separating a group of grains each having a sphericity close to zero from a group of grains each having a sphericity close to 1.

As for the aforementioned inert grain body or the solid catalyst component to be used in the aforementioned separation method, a grain body having a shape different in sphericity from that of a co-existing grain comprising other solid catalyst components is used. Further, the shape separation method is not particularly limited, but the inclined conveyor method is used as a method capable of treating a large quantity.

The inclined conveyor method refers to a method in which a general-purpose belt conveyor is inclined in the direction perpendicular to a belt traveling direction and, performing separation by dropping grain on the conveyor. Separation is performed such that the grain in which the sphericity is close to 1 falls in a vertical direction while the grain in which the sphericity is close to zero falls in a belt traveling direction.

By using the aforementioned inert grain body or the solid catalyst component and adopting the shape separation method, the solid catalyst component and the inert grain body, or the solid catalyst components can efficiently be separated from each other in an easy manner.

(Separation Method 3) Crushing Classification Method

Next, crushing classification method will be described. The crushing used herein means breaking the physical shape of a grain by adding a light impact. The crushing classification method refers herein to a method of performing separation by making use of difference in ease of crushing caused by a difference in the falling strength.

Firstly, 100 g of grains are allowed to fall from an upper portion of a pipe which is made of stainless steel and has an inner diameter of 25 mm and a length of 5 m and stands upright and received by a sheet made of stainless steel having a thickness of 2 mm. The ratio of maintaining a physical shape thereof is defined as the falling strength.

Next, the crushing classification method refers to a method in which the grains are crushed by adding such an impact that 90% or more of the physical shape of the grains will break and then classified.

Specifically, by using an article having different falling strength from that of a grain comprising co-existing other solid catalyst components as the inert grain body or the solid catalyst component, it becomes possible to classify them from each other by use of the crushing classification method.

This crushing classification method is not particularly limited, and a method using a centrifugal crush-sieving machine which allows a dry continuous supply may be used as a method capable of treating a large quantity. In this method, since crushing is performed by a rotary blade portion in a cylinder, crushed grains pass through a screen having given openings and fixed to an outer portion of the cylinder and is efficiently separated from grains which have not been crushed.

By using the aforementioned inert grain body or the solid catalyst component and by adopting the crushing classification method, the solid catalyst component and the inert grain body, or the solid catalyst components can efficiently be separated from each other in an easy manner.

The aforementioned sieving method, shape separation method and crushing classification method may be used individually or in combination thereof. The manner of combination and order thereof may appropriately be selected depending on the type, shape, feature and the like of the inert grain body or the solid catalyst component to be treated.

### EXAMPLES

(Production of Catalyst 1 Grain)

2720 g of nickel nitrate was dissolved in 1800 ml of warm water and 1000 g of silica (trade name: CARPLEX #67; available from Shionogi & Co., Ltd) and 3000 g of antimony trioxide were gradually added with stirring. The resultant solution in a slurry state was condensed by heating and dried at 90° C. Next, the thus-dried mixture was calcined for 3 hours at 800° C. in a muffle furnace. The resultant solid matter was crushed and subjected to sieving to obtain a 60 mesh screen passable product (Sb—Ni—Si—O powder).

Next, 10.8 liter of purified water was heated at about 80° C. and 162 g of ammonium paratungstate, 1278 g of ammonium paramolybdate, 168 g of ammonium metavanadate and 156 g of cuprous chloride were added in this order with stirring to prepare a solution.

Next, the aforementioned Sb—Ni—Si—O powder was gradually added to the thus-prepared solution with stirring and sufficiently mixed. The resultant slurry was condensed by heating at a temperature of 80 to 100° C. and then dried. The thus-dried article was crushed and subjected to sieving to obtain a 24 mesh screen pass product. To the 24 mesh screen pass product, 1.5% by weight of graphite was added and mixed and formed into a cylindrical article having a diameter of 5 mm and a length of 3 mm by using a small-size tableting machine. The thus-formed cylindrical article was calcined for 5 hours at 400° C. in a muffle furnace to obtain a catalyst 1 grain.

(Production of Catalyst 2 Grain)

5.4 kg of ammonium paramolybdate was added to 23 liter of purified water with heating. Next, 412 g of ferric nitrate, 1480 g of cobalt nitrate and 2220 g of nickel nitrate were dissolved in 3.44 liter of purified water with heating. These two resultant solutions were gradually mixed with each other with sufficient stirring to prepare a slurry A.

Next, 48.8 g of borax, 21.8 g of sodium nitrate and 20.6 g of potassium nitrate were dissolved in 2.3 liter of purified water with heating and the solution was added to the slurry A and sufficiently stirred. Then, to the resultant solution 3316 g of bismuth subcarbonate and 3672 g of silicon dioxide were added and stirred to prepare a slurry B.

The thus-prepared slurry B was dried with heating and subjected to a thermal treatment for one hour at 300° C. in an atmosphere of air. The resultant solid article was formed into a cylindrical slope having a diameter of 5 mm and a length of 3 mm by using a small-size tableting machine. Next, the cylindrical article was calcined for 8 hours at 480° C. to obtain a catalyst 2 grain.

(Production of Catalyst 3 Grain)

622.5 g of ammonium paramolybdate, 82.8 g of ammonium metavanadate, 58.1 g of niobium hydroxide and 146.4 g of copper sulfate were added to 2.8 liter of preheated purified water in this order with stirring and dissolved therein or mixed therewith and thereafter dried with heating.

The resultant powder was thermally treated at 240° C. Next, 270 g of the thus-thermally treated powder was added to 270 ml of purified water and sufficiently triturated in a wet state by a milling machine and, thereafter allowed to be carried on 500 g of a spherical a-alumina carrier having an outer diameter of 3mm and then calcined for 3 hours at 380° C. in a nitrogen gas flow in a calcination furnace, to obtain a catalyst 3 grain having an outer diameter of 4.5 mm.

### Example 1

10 liter of a grain mixture in which the aforementioned catalyst 1 grain and a mullite ball of 4.5 mmφ (available from Tipton Corporation) were mixed with each other at the ratio of 60% by volume and 40% by volume, was subjected to a sieving operation by using a SATO VIBRO SEPARATOR 400D-3S (available from Koei Sangyo Co., Ltd.) provided with a screen having a mesh of rectangular openings of 4 mm×12 mm.

By sieving, the ratio of mullite ball contained in an article under the screen was 0% and the ratio of a catalyst grain contained in an article on the screen was 0%.

### Example 2

(Preparation of Grain Mixture (Catalyst-Containing Component))

A grain mixture was prepared in which the aforementioned catalyst 2 grain, the aforementioned mullite ball of 4.5 mm dia, and a ceramic Raschig ring having an outer diameter of 6 mm, and an inner diameter of 3 mm and a length of 5 mm (available from Tipton Corporation) were mixed at the ratio of 50% by volume, 25% by volume and 25% by volume, respectively, while 50% of the catalyst 2 grain and 30% of the Raschig ring were broken ones. A constitution of the grain mixture is shown in Table 1.

TABLE 1

| | Total amount | Ratio of broken | Normal grain | | Broken grain | |
|---|---|---|---|---|---|---|
| | (g) | grain (%) | (g) | (ml) | (g) | (ml) |
| Catalyst 2 | 6250 | 50 | 3125 | 2500 | 3125 | 2250 |
| grain | | | | | | |
| Mullite ball | 2790 | 0 | 2790 | 2500 | — | — |
| Raschig ring | 2778 | 30 | 1945 | 1750 | 833 | 675 |

(Sieving Method)

The aforementioned grain mixture was subjected to sieving by using the same SATO VIBRO SEPARATOR (trade name) as used in Example 1 in which a screen A having a mesh of rectangular openings of 4 mm×12 mm was provided at an upper portion and a screen B having a mesh of square openings of 4 mm was provided under the screen A.

By the sieving, only the mullite ball and the Raschig ring were present on the screen A (4 mm×12 mm screen), the catalyst 2 grain and the broken Raschig ring were present between the screen A and the screen B, and the broken catalyst 2 grain and the broken Raschig ring were present under the screen B (4 mm×4 mm screen). Respective total volumes and grain ratios are shown in Table 2.

TABLE 2

| | | Each grain (% by volume) | | | | | |
|---|---|---|---|---|---|---|---|
| | Entire | Catalyst 2 grain | | Mullite ball | | Raschig ring | |
| | volume | Broken | Normal | Broken | Normal | Broken | Normal |
| | (ml) | grain | grain | grain | grain | grain | grain |
| On screen A | 4250 | 0.0 | 0.0 | — | 58.8 | 0.0 | 41.2 |
| (4 mm × 12 mm) | | | | | | | |
| Between screen A | 2940 | 0.0 | 84.7 | — | 0.0 | 15.3 | 0.0 |
| and screen B | | | | | | | |
| Under screen B | 2725 | 91.7 | 0.0 | — | 0.0 | 8.3 | 0.0 |
| (4 mm × 4 mm) | | | | | | | |

(Shape Separation Method)

The total amount of grain between the screen A and the screen B separated by the sieving operation was subjected to a shape separation operation by using a ROLL SEPARATOR RS-2 (available from Harada Sangyo Co., Ltd.). Separation conditions were as follows:

grain feed speed: 100 kg/h;

grain falling height: 210 mm;

angle of gradient in the direction of conveyor rotation: 8.7°;

angle of gradient in the direction perpendicular to conveyor rotation: −15.5°; and

number of vibration of conveyor belt: 80 Hz

(in which the angle of gradient is an angle against a horizontal plane with a position at which the grain fell on the conveyor as a reference point and an upper side above the horizontal plane was marked as + and a lower side thereof was marked as −).

By the shape separation operation, the catalyst 2 grain and a small amount of the broken Raschig ring fell in the direction perpendicular to the conveyor while the broken Raschig ring and a small amount of the catalyst 2 grain fell in the direction of the conveyor rotation, to classify them from each other. The total volume of each of them and grain ratios are shown in Table 3.

TABLE 3

| | Total | Each grain (% by volume) | |
|---|---|---|---|
| | volume | Catalyst 2 grain | Raschig ring |
| | (ml) | (normal grain) | (broken grain) |
| Falling in the direction | 2451 | 99.6 | 0.4 |
| perpendicular to conveyor | | | |
| Falling in the direction of | 499 | 11.6 | 88.4 |
| conveyor rotation | | | |

(Crushing Classification Method)

Subsequently, the total amount of the grain under the screen B separated by the first sieving operation was subjected to crushing classification operation by using a TURBO SCREENER (available from Matsubo Corporation). Operation conditions were as follows:

grain feed speed: 47 kg/h

cylindrical screen opening: 0.5 mm

number of vibration of TURBO SCREENER: 75 Hz.

By the crushing classification operation, the catalyst 2 grain having a smaller falling strength was crushed and separated in the outside of the cylindrical screen, while the Raschig ring having a larger falling strength was not crushed and separated in the inside of the cylindrical screen. The inside of the screen was denoted as ON while the outside of the screen was denoted as pass and, the separation operation were performed three times in total such that the ON article obtained by a first separation operation was fed as a raw material for the second separation operation and, the ON article obtained by the second separation operation was fed as a raw material for the third separation operation. The falling strength refers herein to the ratio of maintaining the physical shape of a grain when 100 g of such grains are allowed to fall from an upper portion of a pipe made of stainless steel having an inner diameter of 25 mm and a length of 5 m which stands upright and, received by a sheet made of stainless steel having a thickness of 2 mm. The falling strength of the catalyst 2 grain and that of the Raschig ring were 94.0% and 100%, respectively. The results of the separation operation are shown in Table 4.

TABLE 4

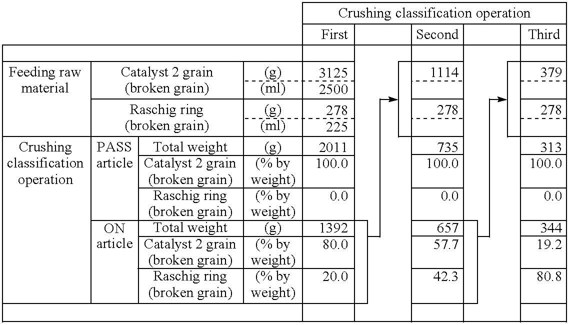

The recovery rate of the catalyst by the aforementioned sieving-shape separation-crushing classification operations was calculated as follows:

catalyst raw material: 6250 g;

amount of article that fell in the direction perpendicular to the conveyor in the shape separation: 3053 g;

total amount of PASS article in crushing classification operation: 2011 g+735 g+313 g=3059 g; and

catalyst recovery rate (%)=(3053+3059)/6250×100=97.8 (%)

### Example 3

10 liter of a catalyst mixture in which the catalyst 2 grain, the catalyst 3 grain and the Raschig ring were mixed at the rates of 45% by weight, 45% by weight and 10% by weight, respectively, was subjected to a sieving operation by using the aforementioned SATO VIBRO SEPARATOR 400D-3S in which a screen A having a mesh of square openings of 5 mm×5 mm was provided at an upper portion, a screen B having a mesh of rectangular openings of 4 mm×12 mm was provided under the screen A, and a screen C having a mesh of square openings of 2 mm×2 mm was provided under the screen B.

By this sieving, only the Raschig ring was present on the screen A (5 mm×5 mm screen) and, further the catalyst 3 grain was present between the screen A and the screen B (4 mm×12 mm screen) and catalyst 2 grain was present between the screen B and the screen C (2 mm×2 mm screen), by 100% in each occurrence and the rates thereof against the amounts to be fed were 99.6% byweightand 99.7% byweight, respectively. Further, a small amount of powder of both the catalyst 2 grain and the catalyst 3 grain was present under the screen C.

### Example 4

(Preparation of Grain Mixture (Catalyst-Containing Component))

A grain mixture was prepared in which the catalyst 2 grain, the catalyst 3 grain and the ceramic Raschig ring were mixed at the ratios of 45% by weight, 45% by weight and 10% by weight, respectively, while 50% of the catalyst 2 grain and 30% of the Raschig ring were broken ones. A constitution of the grain mixture is shown in Table 5.

TABLE 5

| | Total | Ratio of broken | Normal | Broken |
|---|---|---|---|---|
| | amount (g) | grain (%) | grain (g) | grain (g) |
| Catalyst 2 grain | 4500 | 50 | 2250 | 2250 |
| Catalyst 3 grain | 4500 | 0 | 4500 | 0 |
| Raschig ring | 1000 | 30 | 700 | 300 |

(Sieving Method)

The aforementioned grain mixture was subjected to sieving operation by using the SATO VIBRO SEPARATOR 400D-3S (trade name) in which a screen A having a mesh of square openings of 5 mm×5 mm was provided at an upper portion, a screen B having a mesh of rectangular openings of 4 mm×12 mm was provided under the screen A, a screen D having a mesh of square openings of 4 mm×4 mm was provided under the screen B, and a screen E having a mesh of square openings of 1 mm×1 mm was provided under the screen D.

By the aforementioned sieving, only the Raschig ring was present on the screen A (5 mm×5 mm screen), the catalyst 3 grain was present between the screen A and the screen B (4 mm×12 mm screen), the catalyst 2 grain and the broken Raschig ring were present between the screen B and the screen D (4 mm×4 mm screen), and the broken catalyst 2 grain and the broken Raschig ring were present between the screen D and the screen E (1 mm×1 mm screen). Respective total weights and ratios of grains are shown in Table 6. Further, a small amount of powder of both of the catalyst 2 grain and the catalyst 3 grain was present under the screen E.

TABLE 6

| | | Each grain (weight (g)) | | | | | |
|---|---|---|---|---|---|---|---|
| | Total | Catalyst 2 grain | | Catalyst 3 grain | | Raschig ring | |
| | weight | Broken | Normal | Broken | Normal | Broken | Normal |
| | (g) | grain | grain | grain | grain | grain | grain |
| On screen A | 700 | 0 | 0 | — | 0 | 0 | 700 |
| (5 mm × 5 mm) | | | | | | | |
| Between screen A | 4482 | 0 | 0 | — | 4482 | 0 | 0 |
| and screen B | | | | | | | |
| (4 mm × 12 mm) | | | | | | | |
| Between screen B | 2453 | 0 | 2243 | 0 | 0 | 210 | 0 |
| and screen D | | | | | | | |
| (4 mm × 4 mm) | | | | | | | |
| Between screen D | 2317 | 2227 | 0 | 0 | 0 | 90 | 0 |
| and screen E | | | | | | | |
| Under screen E | 48 | 30 | 0 | 18 | 0 | 0 | 0 |
| (1 mm × 1 mm) | | | | | | | |

(Shape Separation Method)

The entire amount of grain between the screen B and the screen D separated by the aforementioned sieving operation was subjected to a shape separation operation in accordance with a shape separation method by using the ROLL SEPARATOR RS-2 (available from Harada Sangyo Co., Ltd.). Separation conditions were as follows:

grain feed speed: 100 kg/h;

grain falling height: 210 mm;

angle of gradient in the direction of conveyor rotation: 8.7°;

angle of gradient in the direction perpendicular to conveyor rotation: −15.5°; and

number of vibration of conveyor belt: 80 Hz

(in which the angle of gradient was an angle against a horizontal plane with a position at which the grain fell on the conveyor as a reference point and an upper side of the horizontal plane was marked as + and a lower side thereof was marked as −).

By the aforementioned shape separation operation, the catalyst 2 grain and a small amount of the broken Raschig ring fell in the direction perpendicular to the conveyor while the broken Raschig ring and a small amount of the catalyst 2 grain fell in the direction of the conveyor rotation, to thereby classify them from each other. The entire weight of each of them and the grain ratio are shown in Table 7.

TABLE 7

| | Total | Each grain (weight (g)) | |
|---|---|---|---|
| | weight | Catalyst 2 grain | Raschig ring |
| | (g) | (normal grain) | (broken grain) |
| Falling in the direction | 2195 | 2190 | 5 |
| perpendicular to conveyor | | | |
| Falling in the direction of | 258 | 53 | 205 |
| conveyor rotation | | | |

(Crushing Classification Method)

Subsequently, an entire amount of the grain between the screen D and the screen E separated by the first sieving operation was subjected to a crushing classification operation in accordance with a crushing classification method by using the TURBO SCREENER (available from Matsubo Corporation). Operation conditions were as follows:

grain feed speed: 4.7 kg/h

cylindrical screen opening: 0.5 mm

number of vibration of TURBO SCREENER: 75 Hz.

By the crushing classification operation, the catalyst 2 grain having a smaller falling strength was crushed and separated in the outside of the cylindrical screen, while the Raschig ring having a larger falling strength was not crushed and separated in the inside of the cylindrical screen. The inside of the screen is denoted as ON while the outside of the screen is denoted as pass and, then the separation operation was performed three times in total such that an ON article obtained by the first separation operation was fed as a raw material for the second separation operation and, subsequently the ON article obtained by the second separation operation was fed as a raw material for the third separation operation. The falling strength of the catalyst 2 grain and that of the Raschig ring were 94.0% and 100%, respectively. The results of the separation operation are shown in Table 8.

TABLE 8

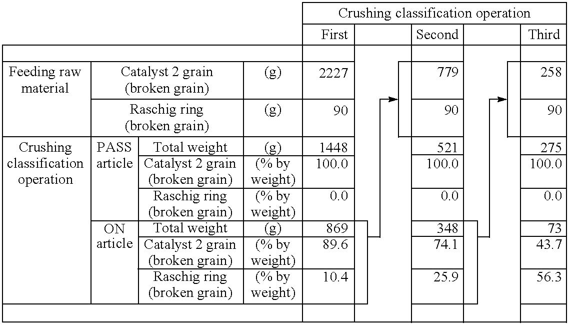

The recovery rate of the catalyst by the sieving-shape separation-crushing classification operation was calculated as follows:

(1. Catalyst 2 grain)

catalyst raw material: .4500 g

amount of article that fell in the direction perpendicular to conveyor in shape separation: 2190 g

Total amount of PASS article in crushing classification operation: 1448 g+521 g+275 g=2244 g; and

catalyst recovery rate (%)=(2190+2244)/4500×100=98.5 (%)

(2. Catalyst 3 grain)

catalyst raw material: 4500 g

sieving: 4482 g

catalyst recovery rate (%)=4482.1 4500×100=99.6 (%).

1. A method for regenerating a catalyst, comprising taking a catalyst-containing component containing a solid catalyst component deteriorated in a reaction, out of a fixed-bed reactor, and regenerating a solid catalyst component.

2. The method for regenerating the catalyst as set forth in claim 1, wherein the catalyst-containing component comprises a component substantially inert to the reaction and, said taking-out step is followed by an inert component separation step for separating the component substantially inert to the reaction.

3. The method for regenerating the catalyst as set forth in claim 2, wherein grains having a minor diameter different from that of the solid catalyst component are used as the component substantially inert to the reaction and in the inert component separation step, sieving is performed by use of a screen having rectangular openings of length a×length b which satisfies the following conditions (1) to (3):
(1) a<b;
(2) a is larger than a minor axis of a grain having a small minor axis and smaller than a minor axis of a grain having a large minor axis; and
(3) b is larger than a major axis of a grain having a small minor axis.

4. The method for regenerating the catalyst as set forth in claim 2, wherein the inert component separation step is a step for performing separation by utilizing a difference in ease of rolling caused by a difference in sphericity between the solid catalyst component and the component substantially inert to the reaction.

5. The method for regenerating the catalyst as set forth in claim 2, wherein the inert component separation step is a step for performing separation by utilizing a difference in ease of crushing caused by a difference in falling strength between the solid catalyst component and the component substantially inert to the reaction.

6. The method for regenerating the catalyst as set forth in claim 1, wherein the solid catalyst component comprises a plurality of components having different shapes from one another and, said taking-out step is followed by catalyst component separation step for separating such solid catalyst components from one another.

7. The method for regenerating the catalyst as set forth in claim 6, wherein the catalyst component separation step is a step of performing sieving by use of a screen having rectangular openings of length a x length b which satisfies the following conditions (1) to (3):
(1) a<b;
(2) a is larger than a minor axis of a grain having a small minor axis and smaller than a minor axis of a grain having a large minor axis; and
(3) b is larger than a major axis of a grain having a small minor axis.

8. The method for regenerating the catalyst as set forth in claim 6, wherein said catalyst component separation step is a step in which separation is performed by utilizing a difference in ease of rolling caused by a difference in sphericity.

9. The method for regenerating the catalyst as set forth in claim 6, wherein said catalyst component separation step is a step in which separation is performed by utilizing a difference in ease of crushing caused by a difference in falling strength.

10. The method for regenerating the catalyst as set forth in claim 1, wherein said solid catalyst component is a compound oxide catalyst comprising, as main components, molybdenum, bismuth and iron, which is used in a process for subjecting propylene, isobutylene or tertiary-butanol to a catalytic vapor-phase oxidation reaction to produce a corresponding unsaturated aldehyde.

11. The method for regenerating the catalyst as set forth in claim 1, wherein said solid catalyst component is a compound oxide catalyst comprising, as main components, molybdenum and vanadium, which is used in a process for subjecting an unsaturated aldehyde to a catalytic vapor-phase oxidation reaction to produce an unsaturated carboxylic acid.

12. The method for regenerating the catalyst as set forth in claim 2, wherein the solid catalyst component comprises a plurality of components having different shapes from one another and, said taking-out step is followed by catalyst component separation step for separating such solid catalyst components from one another.

13. The method for regenerating the catalyst as set forth in claim 2, wherein said solid catalyst component is a compound oxide catalyst comprising, as main components, molybdenum, bismuth and iron, which is used in a process for subjecting propylene, isobutylene or tertiary-butanol to a catalytic vapor-phase oxidation reaction to produce a corresponding unsaturated aldehyde.

14. The method for regenerating the catalyst as set forth in claim 3, wherein said solid catalyst component is a compound oxide catalyst comprising, as main components, molybdenum, bismuth and iron, which is used in a process for subjecting propylene, isobutylene or tertiary-butanol to a catalytic vapor-phase oxidation reaction to produce a corresponding unsaturated aldehyde.

15. The method for regenerating the catalyst as set forth in claim 4, wherein said solid catalyst component is a compound oxide catalyst comprising, as main components, molybdenum, bismuth and iron, which is used in a process for subjecting propylene, isobutylene or tertiary-butanol to a catalytic vapor-phase oxidation reaction to produce a corresponding unsaturated aldehyde.

16. The method for regenerating the catalyst as set forth in claim 5, wherein said solid catalyst component is a compound oxide catalyst comprising, as main components, molybdenum, bismuth and iron, which is used in a process for subjecting propylene, isobutylene or tertiary-butanol to a catalytic vapor-phase oxidation reaction to produce a corresponding unsaturated aldehyde.

17. The method for regenerating the catalyst as set forth in claim 6, wherein said solid catalyst component is a compound oxide catalyst comprising, as main components, molybdenum, bismuth and iron, which is used in a process for subjecting propylene, isobutylene or tertiary-butanol to a catalytic vapor-phase oxidation reaction to produce a corresponding unsaturated aldehyde.

18. The method for regenerating the catalyst as set forth in claim 7, wherein said solid catalyst component is a compound oxide catalyst comprising, as main components, molybdenum, bismuth and iron, which is used in a process for subjecting propylene, isobutylene or tertiary-butanol to a catalytic vapor-phase oxidation reaction to produce a corresponding unsaturated aldehyde.

19. The method for regenerating the catalyst as set forth in claim 8, wherein said solid catalyst component is a compound oxide catalyst comprising, as main components, molybdenum, bismuth and iron, which is used in a process for subjecting propylene, isobutylene or tertiary-butanol to a catalytic vapor-phase oxidation reaction to produce a corresponding unsaturated aldehyde.

20. The method for regenerating the catalyst as set forth in claim 9, wherein said solid catalyst component is a compound oxide catalyst comprising, as main components, molybdenum, bismuth and iron, which is used in a process for subjecting propylene, isobutylene or tertiary-butanol to a catalytic vapor-phase oxidation reaction to produce a corresponding unsaturated aldehyde.

21. The method for regenerating the catalyst as set forth in claim 2, wherein said solid catalyst component is a compound oxide catalyst comprising, as main components, molybdenum and vanadium, which is used in a process for subjecting an unsaturated aldehyde to a catalytic vapor-phase oxidation reaction to produce an unsaturated carboxylic acid.

22. The method for regenerating the catalyst as set forth in claim 3, wherein said solid catalyst component is a compound oxide catalyst comprising, as main components, molybdenum and vanadium, which is used in a process for subjecting an unsaturated aldehyde to a catalytic vapor-phase oxidation reaction to produce an unsaturated carboxylic acid.

23. The method for regenerating the catalyst as set forth in claim 4, wherein said solid catalyst component is a compound oxide catalyst comprising, as main components, molybdenum and vanadium, which is used in a process for subjecting an unsaturated aldehyde to a catalytic vapor-phase oxidation reaction to produce an unsaturated carboxylic acid.

24. The method for regenerating the catalyst as set forth in claim 5, wherein said solid catalyst component is a compound oxide catalyst comprising, as main components, molybdenum and vanadium, which is used in a process for subjecting an unsaturated aldehyde to a catalytic vapor-phase oxidation reaction to produce an unsaturated carboxylic acid.

25. The method for regenerating the catalyst as set forth in claim 6, wherein said solid catalyst component is a compound oxide catalyst comprising, as main components, molybdenum and vanadium, which is used in a process for subjecting an unsaturated aldehyde to a catalytic vapor-phase oxidation reaction to produce an unsaturated carboxylic acid.

26. The method for regenerating the catalyst as set forth in claim 7, wherein said solid catalyst component is a compound oxide catalyst comprising, as main components, molybdenum and vanadium, which is used in a process for subjecting an unsaturated aldehyde to a catalytic vapor-phase oxidation reaction to produce an unsaturated carboxylic acid.

27. The method for regenerating the catalyst as set forth in claim 8, wherein said solid catalyst component is a compound oxide catalyst comprising, as main components, molybdenum and vanadium, which is used in a process for subjecting an unsaturated aldehyde to a catalytic vapor-phase oxidation reaction to produce an unsaturated carboxylic acid.

28. The method for regenerating the catalyst as set forth in claim 9, wherein said solid catalyst component is a compound oxide catalyst comprising, as main components, molybdenum and vanadium, which is used in a process for subjecting an unsaturated aldehyde to a catalytic vapor-phase oxidation reaction to produce an unsaturated carboxylic acid.
